(19) United States
(12) Patent Application Publication
(10) Pub. No.: US 2007/0086515 A1
(43) Pub. Date: Apr. 19, 2007

(54) Spatial and snr scalable video coding

(75) Inventors: Ihor Kirkenko, Eindhoven (NL); Taras Telyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkiljke Phillips Electronics N.V.

(21) Appl. No.: 10/580,673

(22) PCT Filed: Dec. 8, 2004
(86) PCT No.: PCT/IB04/52718

§ 371 Date: May 26, 2006

Related U.S. Application Data
(60) Provisional application No. 60/528,165, filed on Dec. 9, 2003.
(60) Provisional application No. 60/547,922, filed on Feb. 26, 2004.

(51) Int. Cl. H04B 1/66

(52) U.S. Cl. 375/240.1; 375/240.27

(57) ABSTRACT

An SNR and spatial scalable video coder uses standards compatible encoding units (303, 310, 320) to produce abase layer encoded signal (130) and at least two enhanced layer encoded signals (314, 325). The base layer and at least the first enhanced layer are produced from a downscaled signal (200). At least one additional enhanced layer is produced from an upscaled signal (321). Advantageously, a single encoder/decoder pair can be used, in combination with feedback, switches, and offsets to produce all layers of the scalable coding. Modular design allows an arbitrary number of either spatial or SNR scalable encoded layers and error correction for all but the last layer. All encoders operate in the pixel domain. Decoders are also shown.

### CROSS REFERENCE TO RELATED APPLICATION

This application claims the benefit of U.S. provisional application Ser. No. 60/528,165 filed Dec. 9, 2003, and application Ser. No. 60/547,922 filed Feb. 26, 20043, which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The invention relates to the field of scalable digital video coding.

US published patent application 2002/0071486 shows a type of coding with spatial and SNR scalability. Scalability is achieved by encoding a downscaled base layer with quality enhancement layers. It is a drawback of the scheme shown in this application that the encoding is not standards compatible. It is also a drawback that the encoding units are of a non-standard type.

It would be desirable to have encoding that is both SNR and spatial scalable video coding, with more than one enhancement encoding layer, with all the layers being compatible with at least one standard. It would further be desirable to have at least the first enhancement layer be subject to some type of error correction feedback. It would also be desirable for the encoders in multiple layers not to require internal information from prior encoders, e.g. by use of at least one encoder/decoder pair.

In addition, it would be desirable to have an improved decoder for receiving an encoded signal. Such a decoder would preferably include a decoding module for each encoded layer, with all the decoding modules being identical and compatible with at least one standard.

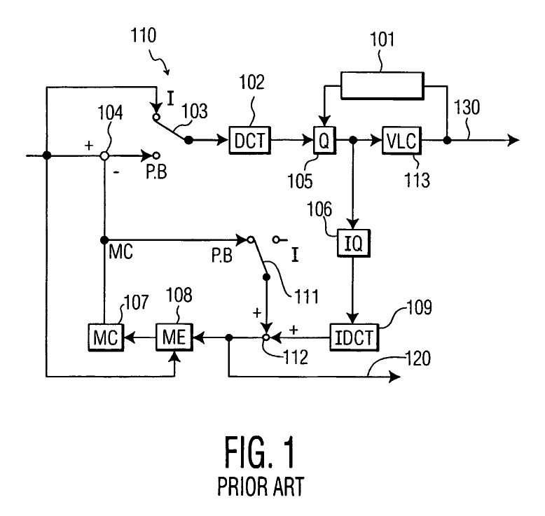

FIG. 1 shows a prior art base-encoder

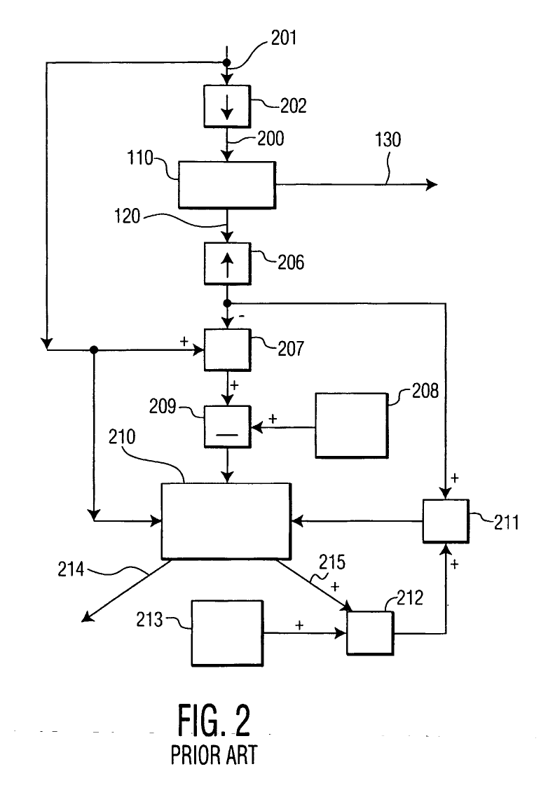

FIG. 2 shows a prior art scalable encoder with only one layer of enhancement

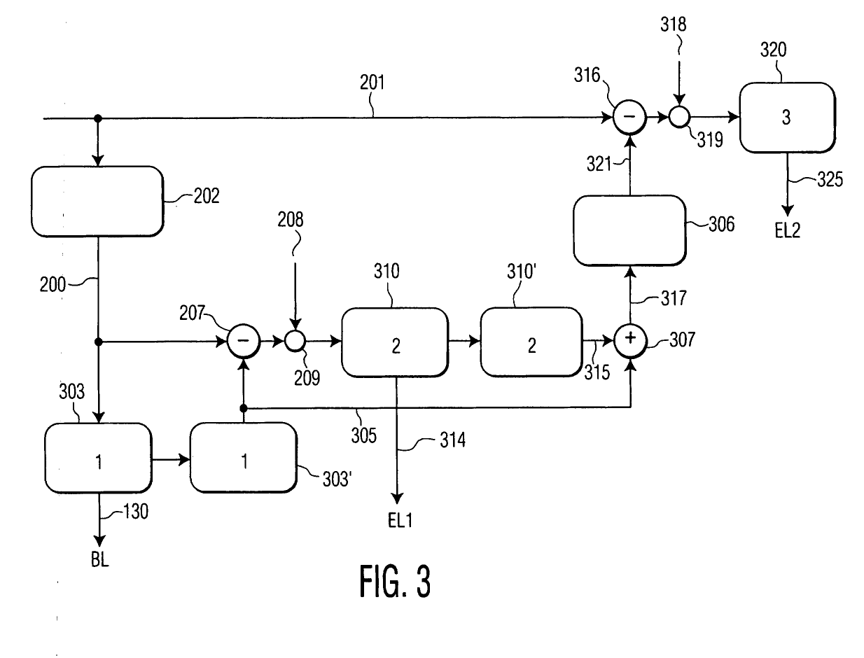

FIG. 3 shows a scalable encoder in accordance with the invention with two layers of enhancement.

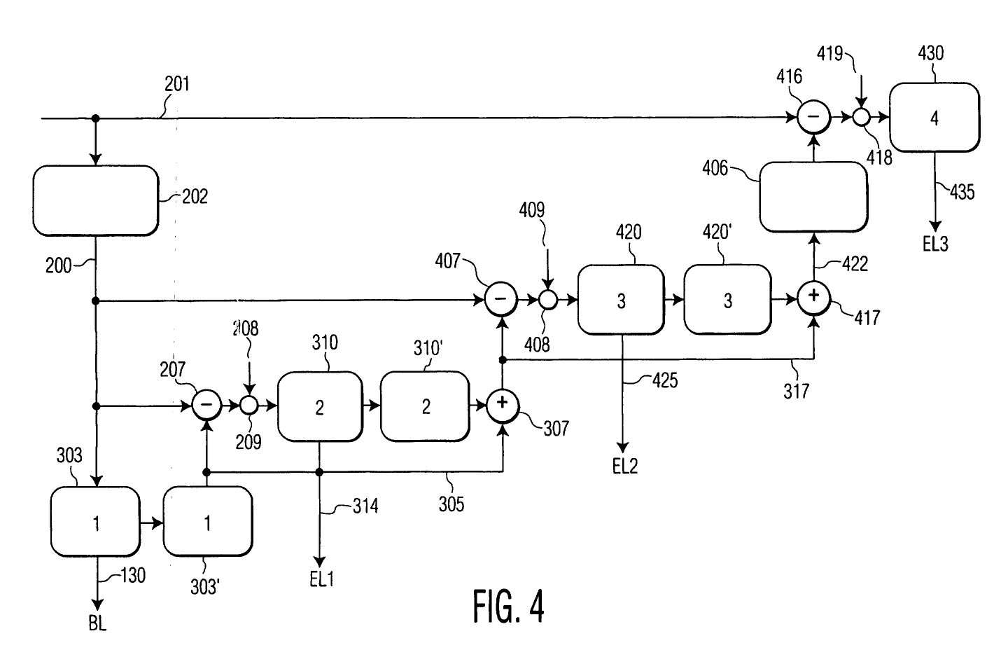

FIG. 4 shows an alternative embodiment of a scalable encoder in accordance with the invention with 3 layers of enhancement.

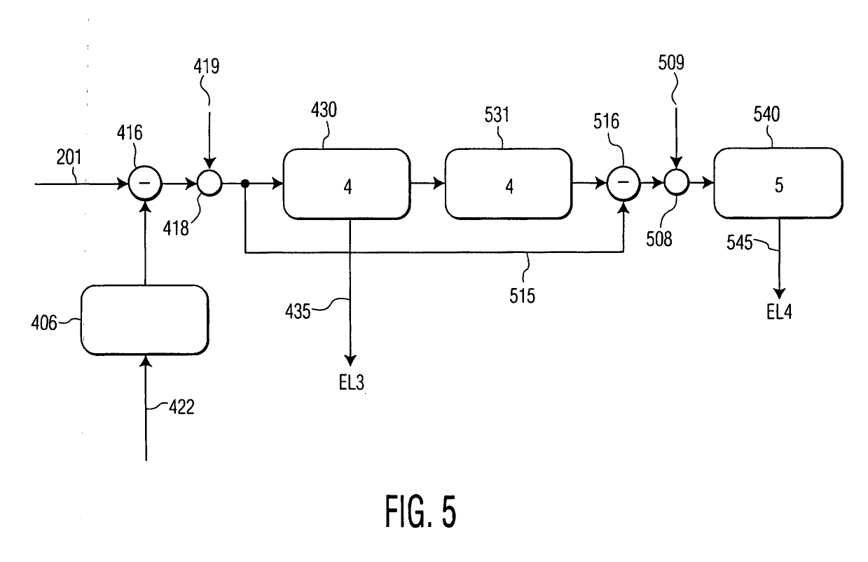

FIG. 5 shows an add-on embodiment for adding a fourth layer of enhancement to the embodiment of FIG. 4.

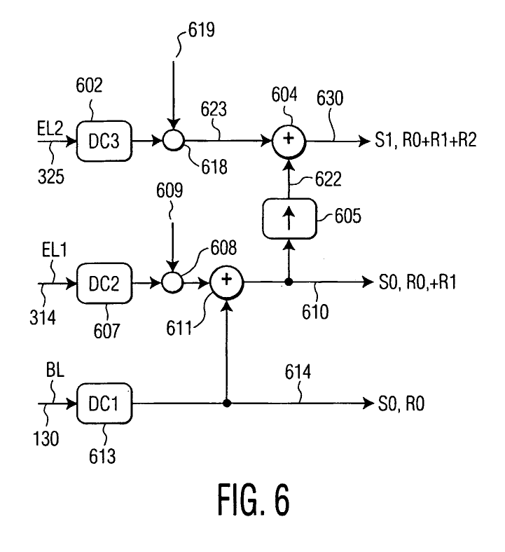

FIG. 6 shows a decoder for use with two enhancement layers.

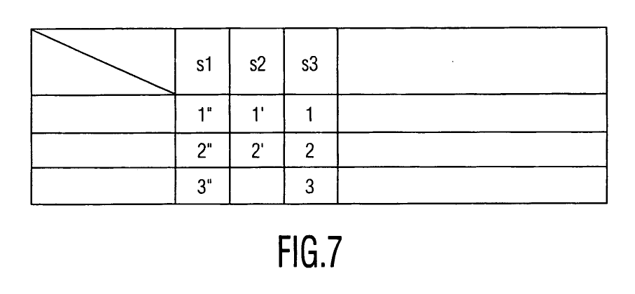

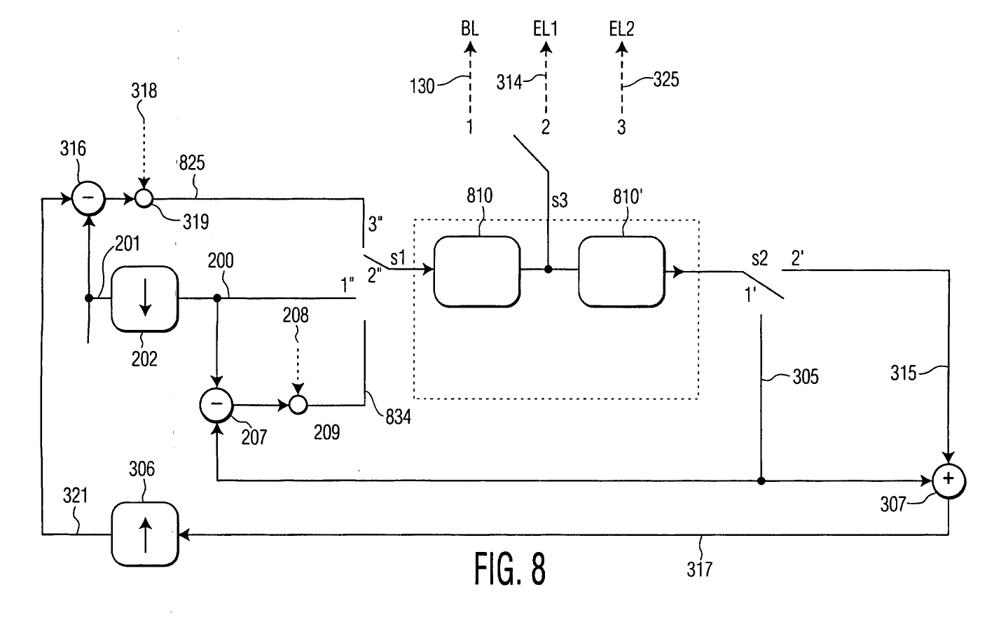

FIG. 7 is a table for use with FIG. 8

FIG. 8 shows an embodiment with only one encoder/decoder pair that produces two layers of enhancement.

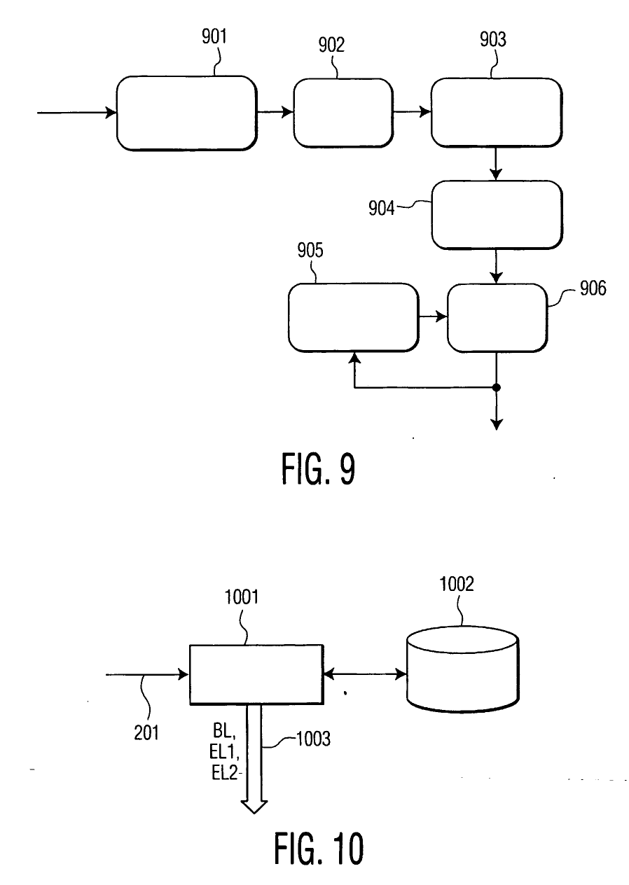

FIG. 9 shows a decoder.

FIG. 10 shows a processor and memory for a software embodiment.

Published patent application US 2003/0086622 A1 is incorporated herein by reference. That application includes a base encoder 110 as shown in FIG. 1. In this base encoder are the following components: a motion estimator (ME) 108; a motion compensator (MC) 107; an orthogonal transformer (e.g. discrete cosine transformer DCT) 102; a quantizer (Q) 105; a variable length coder (VLC) 113, birate control circuit 101; an inverse quantizer (IQ) 106; inverse transform circuit (IDCT) 109; switches 103 and 111, subtractor 104 & adder 112. For more explanation of the operation of these components the reader is referred to the published patent application. The encoder both encodes the signal, to yield the base stream output 130, and decodes the coded output, to yield the base-local decoded output 120. In other words, the encoder can be viewed as an encoder and decoder together.

This base-encoder 110 is illustrated only as one possible embodiment. The base-encoder of FIG. I is standards compatible, being compatible with standards such as MPEG 2, MPEG 4, and H. 26×. Those of ordinary skill in the art might devise any number of other embodiments, including through use of software or firmware, rather than hardware. In any case, all of the encoders described in the embodiments below are assumed, like FIG. 1, to operate in the pixel domain.

In order to give scalability, the encoder of FIG. 1 is combined in the published patent application with a second, analogous encoder, per FIG. 2. In this figure, both base encoder 110 and enhancement signal encoder 210 are essentially the same, except that the enhancement signal decoder 210 has a couple of extra inputs to the motion enhancement (ME) unit. The input signal 201 is downscaled at 202 to produce downscaled input signal 200. Then the base encoder 110 takes the downscaled signal and produces two outputs, a base stream 130, which is the lower resolution output signal, and a decoded version of the base stream 120, also called the base-local-decoded-output. This output 120 is then upscaled at 206 and subtracted at 207 from the input signal 201. A DC offset 208 is added at 209. The resulting offset signal is then submitted to the enhancement signal encoder 210, which produces an enhanced stream 214. The encoder 210 is different from the encoder 110 in that an offset 213 is applied to the decoded output 215 at adder 212 and the result is added at 211 to the upscaled base local decoded output prior to input to the ME unit. By contrast, the base-local-decoded input is applied without offset to the ME unit 108 in the base encoder 110 and without combination with any other input signal. The input signal 201 is also input to the ME unit within encoder 210, as in base-encoder 110.

FIG. 3 shows an encoder in accordance with the invention. In this figure, components which are the same as those shown in FIG. 2 are given the same reference numerals.

US 2003/0086622 A1 elected to use the decoding portions of the standard encoder of FIG. 1 to produce the base-local-decoded output 120 and the decoded output 215. However, though this looks advantageous, because only one set of decoding blocks needs to be used and error drift is hypothetically decreased, nevertheless certain disadvantages arise. The design of FIG. 2 requires modifications to standard encoders to get the second output. This increases cost, complexity and limits architecture choices. Moreover, in future video coder standards, such as the wavelet-based codec proposed recently for MPEG, the local decoding loop may not exist at all in standard decoders. As a result, in the preferred embodiment herein, a separate decoder block 303′ was added, rather than trying to extract the decoded signal out of block 303. In FIGS. 3-5 and 8 all of the encoders are presumed to be of a single standard type, e.g. approximately the same as that shown in FIG. 1, or of any other standard type such as is shown in MPEG 2, MPEG 4, H.263, H.264, and the like. Similarly, all of the decoders FIGS. 3-6 and 8 are assumed to be of a single, standard type such as are shown in MPEG 2, MPEG 4, H.263, H.264, and the like; or as shown in FIG. 9. Nevertheless, one of ordinary skill in the art might make substitutions of encoders or decoders as a matter of design choice. The term “encoder/decoder pair” as used herein, means that the decoded signal used for a successive encoded layer comes from a separate decoder, not from the local decoded signal in the encoder.

The designer might nevertheless chose to use the type of embodiment shown in US 2003/0086622 A1, i.e. taking the local decoded signal out of the block 110, rather than using an encoder/decoder pair 303, 303′, and still get both SNR and spatial enhancement, with standards compatibility, operating in the pixel domain.

In order to create a second enhancement layer, the upscaling unit 306 is moved downstream of the encoder/decoder pair 310, 310′. Standard coders can encode all streams (BL, EL1, EL2), because BL is just normal video of a down-scaled size, and EL signals after operation of “offset” have a pixel range of a normal video. One can use exactly the same coder for encoding of all layers, but parameters of coding may be different and are optimized for particular layer. The input parameters to standard encoders may be: resolution of input video, size of GOF (Group of Frames), required bit-rate, number of I, P, B frames in GOF, restrictions to motion estimation, etc. These parameters are defined in the description of the relevant standards, such as MPEG-2, MPEG-4 or H.264. In the final streams the encoded layers should be differentiated somehow, e.g. by introducing additional headers, transmitting them in different physical channels, or the like.

The enhanced layer encoded signal (EL1) 314 is analogous to 214, except produced from the downscaled signal. The decoded output 315, analogous to 215, but now in downscaled version, is added at 307 to the decoded output 305, which is analogous to output 120. The output 317 of adder 307 is upscaled at 306. The resulting upscaled signal 321 is subtracted from the input signal 201 at 316. To put the voltage in the correct range for further encoding, an offset 318, analogous to 208, is added at 319. Then an output of the adder 319 is encoded at 320 to yield second enhanced layer encoded signal (EL2) 325. In comparing FIGS. 3 and 2, it can be seen that not only is there an additional layer of enhancement but also the ELI signal is subject to error correction that the enhanced layer is not subject to in FIG. 2.

FIG. 4 shows an embodiment of the invention with a third enhancement layer. Elements from prior drawings are given the same reference numerals as before and will not be re-explained. The upscaling 406 has been moved to the output of the second enhancement layer. In general, it is not mandatory to make upscaling immediately before the last enhancement layer.

The output 317 of adder 307 is no longer upscaled. Instead it is input to subtractor 407 and adder 417. Subtractor 407 calculates the difference between signal 317 and downscaled input signal 200. Then a new offset 409 is applied at adder 408. From the resulting offset signal, a third encoder 420, this time operating at the downscaled level, creates the second enhanced encoded layer EL2 425, which is analogous to EL2 325 from FIG. 3. A new, third decoder 420′ produces a new decoded signal which is added at 417 to the decoded signal 317 to produce a sum 422 of the decoded versions of BL, EL1, and EL2. The result is then upscaled at 406 and subtracted at 416 from input signal 201. Yet another offset 419 is applied at 418 and input to fourth encoder 430 to produce a third enhanced layer decoded signal (EL3) 435.

Offset values can be the same for all layers of the encoders of FIGS. 3-5 and 8 and depend on the value range of the input signal. For example, suppose pixels of the input video have 8-bit values that range from 0 up to 255. In this case the offset value is 128. The goal of adding offset value is to convert the difference signal (which has both positive and negative values) into the range of only positive values from 0 to 255. Theoretically, it is possible, that with an offset of 128 some values bigger than 255 or lower than 0 may appear. Those values can be cropped to 255 or 0 correspondingly. One of ordinary skill in the art might devise other solutions to put the difference signal with the pixel range of the natural video signal. An inverse offset can be used on the decoding end as shown in FIG. 6.

FIG. 5 shows an add-on to FIG. 4, which yields another enhancement layer, where again reference numerals from previous figures represent the same elements that they represented in the previous figures. This add-on allows for a fourth enhancement layer to be produced. Added in this embodiment are fourth decoder 531, feed forward 515, subtractor 516, adder 508, offset 509, encoder 540, and output 545. The fifth encoder 540 provides fourth enhanced layer encoded signal (EL4) 545. All of the new elements operate analogously to the similar elements in the prior figures. In this case encoders 4 and 5 both operate at the original resolution. They can provide two additional levels of SNR (signal-o-noise) scalability.

Thus with FIG. 5 there are a base layer, and 4 enhanced layers, of encoded signals, allowing for 3 levels of SNR scalability at low resolution:
1—BL;
2—BL+EL1;
3—BL+EL1+EL2;
   and two SNR scalable levels at the original resolution:
1—EL3;
2—EL3+EL4.

In this example, only two levels of spatial scalability are provided: original resolution and once-downscaled. The number and content of the layers are defined during encoding. The sequence has been down-scaled and up-scaled only once at the encoding side, therefore it is possible to reconstruct at the decoding side only two spatial layers (original size and down-scaled). The above-mentioned five decoding scenarios are maximum allowed. The user can chose either to gradually decode all 5 streams, or only some of them. In general, the number of decoded layers will be limited by the number of layers generated by the encoder.

The embodiments of FIGS. 4 and 5 show the flexibility of the design of using self-contained encoder/decoder pairs operating in the pixel domain. It becomes very easy to add more enhancement layers. The designer will be able to device many other configurations with different numbers of levels of both types of scalability. Additional downscaling and upscaling units will have to be added to give more layers of spatial resolution.

FIG. 6 shows decoding on the receiving end for the signal produced in accordance with FIG. 3. FIG. 6 has three decoders, all of the same standard sort as the decoders shown in FIGS. 3-5, an example of which is shown in FIG. 9. BL 130 is input to a first decoder CD1 613. How separate layers are transmitted, received and routed to the decoders depends on the application; is a matter of design choice, outside the scope of the invention; and is handled by the channel coders, packetizers, servers, etc. The coding standard MPEG 2 includes a so-called “system level”, which defines the transmission protocol, receiving of the stream by decoding, synchronization, etc.

The output 614 is of a first spatial resolution S0 and a bit rate R0. EL1 314 is input to a second decoder DC2 607. An inverse offset 609 is then added at adder 608 to the decoded version of ELI. Then the decoded version 614 of BL is added in by adder 611. The output 610 of the adder 611 is still at spatial resolution S0. In this case EL1 gives improved quality at the same resolution as BL, i.e. SNR scalability, but EL2 gives improved resolution, i.e. spatial scalability. The bit rate is augmented by the bit rate R1 of EL1. This means that at 610 there is a combined bit rate of R0+R1. Output 610 is then upscaled at 605 to yield upscaled signal 622. EL2 325 is input to third decoder 602. An inverse offset 619 is then added at 618 to the decoded version of EL2 to yield an offset signal-output 623. This offset signal 623 is then added at 604 to upscaled signal 622 to yield output 630, which has a spatial resolution S1, where S0=¼S1, and a bit rate of R0+R1+R2, where R2 is the bit rate of EL2. The ratio between S1 and S0 is a matter of design choice and depends on application, resolution of original signal, display size etc. The S1 and S0 resolutions should be supported by the exploited standard encoders/decoders. The case mentioned is the simplest case, i.e. where the low-resolution image is 4 times smaller than the original. But in general any resolution conversion ratio may be used.

FIG. 8 shows an alternate embodiment of FIG. 3. Some of the same reference numerals are used as in FIG. 3, to show correspondence between elements of the drawing. In this embodiment only one encoder/decoder pair 810, 810′ is used. Switches s1, s2, and s3 allow this pair 810, 810′ to operate first as coder 1 (303) and decoder 1 (303′), then as coder 2 (310) and decoder 2 (310′), and finally as coder 3 (320), all as shown in FIG. 3. The positions of the switches are governed by the table of FIG. 7.

First, input 201 is downscaled at 202 to create downscaled signal 200, which passes to switch s1, in position 1″ to allow the signal to pass to coder 810. Switch s3 is now in position 1 to produces BL 130.

Then BL is also decoded by decoder 810′ to produce a local decoded signal, BL DECODED 305. Switch s2 is now in position 1′ so that BL DECODED 305 is subtracted from signal 200 at 207. Offset 208 is added at 209 to the difference signal from 207 to create EL1 INPUT 834. At this point switch s1 is in position 2″, so that signal 834 reaches coder 810. Switch s3 is in position 2, so that EL1 reaches output 314.

EL1 also goes to decoder 810′ to produce EL1 DECODED 315, which is added to BL DECODED 305—still latched at its prior value—using adder 307. Memory elements, if any, used to make sure that the right values are in the right place at the right time are a matter of design choice and have been omitted from the drawing for simplicity. The output 317 of adder 307 is then upscaled at unit 306. The upscaled signal 321 is then subtracted from the input signal 201 at subtractor 316. To the result offset 318 is added at 319 to produce EL2 INPUT 825. Switch s1 is now in position 3″ so that EL2 INPUT 825 passes to coder 810, which produces signal EL2. Switch s3 is now in position 3, so that EL2 becomes available on line 325.

The embodiment of FIG. 8 is advantageous in saving circuitry over the embodiment of FIG. 3, but produces the same result.

The scheme of SNR+spatial scalable coding of FIG. 8 has been implemented and its performance has been compared against the schemes of 2-layers spatial scalable coding and single layer high resolution coding. The latest version (JM6.1a) of H.264 encoder was used for test purposes. The test sequence “matchline” and high resolution enhancement layer EL2 had the SD (Standard Definition) resolution (704×576 pixels); the signals BL and EL1 had the SIF resolution. SIF (Standard Input Format) is the format for compressed video specified by the MPEG committee, with resolutions of 352 (horizontal)×240 (vertical)×29.97 (fps) for NTSC and 352 (horizontal)×288 (vertical)×25.00 (fps) for PAL. SIF-resolution video provides an image quality similar to VHS tape. The sequence “matchline” had 160 frames at 25 fr/sec.

Bit rates of the scheme of FIG. 8 were: BL - 547 kbit/s, EL1 - 1448 kbit/s, EL2 -1059 kbit/s. The bit rates of 2-layer only spatial scalable scheme of US 2003/086622 were: BL (SIF) - 1563 kbit/s, EL (SD) - 1469 kbit/s. The bit-rate of single layer H.264 coder was 2989 kbit/s

The total bit-rate of each scheme at SD resolution was approximately 3 Mbit/s.

The PSNR (Peak Signal to Noise Ratio) luminance values of sequence decoded at SD resolution are following:

| SNR + spatial (FIG. 8) | spatial (2-layers) | single layer |
|---|---|---|
| 40.28 | 40.74 | 41.42 |

Therefore, the scheme of FIG. 8 provides almost the same quality (objectively as well as subjectively) as the 2 layer spatial scalable scheme, but has also SNR scalability.

FIG. 9 shows a decoder module suitable for use in FIGS. 3-6 and 8. An encoded stream is input to variable length decoder 901, which is analogous to element 113. The result is subjected to an inverse scan at 902, then to an inverse quantization 903, which is analogous to box IQ 106. Then the signal is subjected to inverse discrete cosine transform 904, which is analogous to box 109. Subsequently the signal goes to a motion compensation unit 906, which is coupled to a feedback loop via a frame memory 905. An output of the motion compensation unit 906 gives the decoded video. The decoder implements MC based on motion vectors decoded from the encoded stream.

A description of a suitable decoder may also be found in the MPEG 2 standard (ISO/IEC 13818-2, FIG. 7-1).

FIGS. 3-5, 6, and 9 can be viewed as either hardware or software, where-the boxes are hardware or software modules and the lines between the boxes are actual circuits or software flow. The terms “encoder” or “decoder” as used herein can refer to either hardware or software modules. Similarly the adders, subtractors, and other items in the diagrams can be viewed as hardware or software modules. Moreover, different encoders or decoders may be spawned copies of the same code as the other encoders or decoders, respectively.

All of the encoders and decoders shown with respect to the invention are assumed to be self-contained. They do not require internal processing results from other encoders or decoders.

The encoders of FIGS. 3-5 may operate in a pipelined fashion, for efficiency.

From reading the present disclosure, other modifications will be apparent to persons skilled in the art. Such modifications may involve other features which are already known in the design, manufacture and use of digital video coding and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements.

FIG. 10 shows a processor 1001 receiving video input 201 and outputting the scalable layers BL, EL1, and EL2 at 1003. This embodiment is suitable for software embodiments of the invention. The processor 1001 uses a memory device 1002 to store code and/or data. The processor 1001 may be of any suitable type, such as a signal processor. The memory 1002 may also be of any suitable type including magnetic, optical, RAM, or the like. There may be more than one processor and more than one memory. The processor and memory of FIG. 10 may be integrated into a larger device such as a television, telephone, or computer. The encoders and decoders shown in the previous figures may be implemented as modules within the processor 1001 and/or memory 1002.

The plural encoders of FIGS. 3-5 may be implemented as spawned copies of a single encoder module.

The following pages show a configuration file for use with a standard H.264 encoder in order to implement the embodiment of FIG. 8. This configuration is only one example of many different configurations that the skilled artisan might devise for implementing the invention.

©2004 Koninklijke Philips Electronics, N.V.
# New Input File Format is as follows
# <ParameterName> = <ParameterValue> # Comment
#
# See configfile.h for a list of supported ParameterNames
##########################################################################################
# Files
##########################################################################################

| | | |
|---|---|---|
| InputFile | = “sequence_filename” | # Input sequence, YUV 4:2:0 |

| | | |
|---|---|---|
| InputHeaderLength | = 0 | # If the inputfile has a header, state it's length in byte |
| here | | |

| | | |
|---|---|---|
| FramesToBeEncoded | = number_of_frames | # Number of frames to be coded |

| | | |
|---|---|---|
| SourceWidth | = width | # Image width in Pels, must be multiple of 16 |
| SourceHeight | = height | # Image height in Pels, must be multiple of 16 |

| | |
|---|---|
| TraceFile | = “trace.txt” |
| ReconFile | = “rec.yuv” |
| OutputFile | = “output_file.h264” |

##########################################################################################
# Encoder Control
##########################################################################################

| | | |
|---|---|---|
| IntraPeriod | = 0 | # Period of I-Frames (O=only first) |

| | | |
|---|---|---|
| QPFirstFrame | = qp_value | # Quant. param for first frame (intra) (0-51) |
| QPRemainingFrame | = qp_value | # Quant. param for remaining frames (0-51) |

| | | |
|---|---|---|
| FrameSkip | = 2 | # Number of frames to be skipped in input (e.g 2 will code |
| every third frame) | | |
| UseHadamard | = 1 | # Hadamard transform (0=not used, 1= used) |
| SearchRange | = 32 | # Max search range |
| NumberReferenceFrames | = 2 | #Number of previous frames used for inter motion search (1-5) |
| MbLineIntraUpdate | = 0 | #Error robustness (extra intra macro block updates) (0=off, N: |

One GOB every N frames are intra coded)

| | | |
|---|---|---|
| RandomIntraMBRefresh | = 0 | # Forced intra MBs per picture |
| InterSearch16×16 | = 1 | # Inter block search 16×16 (0=disable, 1=enable) |
| InterSearch16×8 | = 1 | # Inter block search 16×8 (0=disable, 1=enable) |
| InterSearch8×16 | = 1 | # Inter block search 8×16 (0=disable, 1=enable) |
| InterSearch8×8 | = 1 | # Inter block search 8×8 (0=disable, 1=enable) |
| InterSearch8×4 | = 1 | # Inter block search 8×4 (0=disable, 1=enable) |
| InterSearch4×8 | = 1 | # Inter block search 4×8 (0=disable, 1=enable) |
| InterSearch4×4 | = 1 | # Inter block search 4×4 (0=disable, 1=enable) |

##########################################################################################
# Error Resilience / Slices
##########################################################################################

| | | |
|---|---|---|
| SliceMode | = 0 | # Slice mode (0=off 1=fixed #mb in slice 2=fixed #bytes in |
| slice 3=use callback 4=FMO) | | |
| SliceArgument | = 50 | # Slice argument (Arguments to modes 1 and 2 above) |
| num_slice_groups_minus1 | = 0 | # Number of Slice Groups Minus 1, 0 == no FMO, 1 == two slice |
| groups, etc. | | |
| FmoType | = 0 | # 0: Slice interleave, 1: Scatter, 2: fully flexible, data in |
| FmoConfigFileName, | | |
| | | # 3: rectangle defined by FmoTopLeftMB and FmoBottomRightMB, |
| | | # (only one rectangular slice group supported currently, |
| i.e. FmoNumSliceGroups = 1) | | |
| | | # 4 -6:evolving slice groups, FmoNumSliceGroups = 1, the |
| evolving method is defined by | | |
| | | # FmoChangeDirection and FmoChangeRate. |
| FmoTopLeftMB | = 24 | # the top left MB of the rectangular shape for slice groups, |

MB counted in raster scan order

| | | |
|---|---|---|
| FmoBottomRightMB | = 74 | # the bottom right MB of the rectangular shape for slice |
| groups | | |
| FmoChangeDirection | = 1 | # 0: box-out clockwise, raster scan or wipe right, |
| | | # 1: box-out counter clockwise, reverse raster scan or wipe |
| left | | |
| FmoChangeRate | = 4 | # SLICE_GROUP_CHANGE_RATE minus 1 |

| | | |
|---|---|---|
| FmoConfigFileName | = “fmoconf.cfg” | # not yet used, for future fully flexible MBAmaps |

| | | |
|---|---|---|
| UseRedundantSlice | = 0 | # 0: not used, 1: one redundant slice used for each slice |

(other modes not supported yet)
##########################################################################################
# B Frames
##########################################################################################

| | | |
|---|---|---|
| NumberBFrames | = 2 | # Number of B frames inserted (0=not used) |

| | | |
|---|---|---|
| QPBPicture | = qpb_value | # Quant. param for B frames (0-51) |

| | | |
|---|---|---|
| DirectModeType | = 1 | # Direct Mode Type (0:Temporal 1:Spatial) |

##########################################################################################
# SP Frames
##########################################################################################

| | | |
|---|---|---|
| SOPPicturePeriodicity | = 0 | # SP-Picture Periodicity (0=not used) |
| QPSPPicture | = 28 | # Quant. param of SP-Pictures for Prediction Error (0-51) |
| QPSP2Picture | = 27 | # Quant. param of SP-Pictures for Predicted Blocks (0-51) |

##########################################################################################
# Output Control, NALs
##########################################################################################

| | | |
|---|---|---|
| SymbolMode | = 1 | # Symbol mode (Entropy coding method: 0=UVLC, 1=CABAC) |
| OutFileMode | = 0 | # Output file mode, 0:Annex B, 1:RTP |
| PartitionMode | = 0 | # Partition Mode, 0: no DP, 1: 3 Partitions per Slice |

##########################################################################################
# Search Range Restriction / RD Optimization
##########################################################################################

| | | |
|---|---|---|
| RestrictSearchRange | = 2 | # restriction for (0: blocks and ref, 1: ref, 2: no |
| restrictions) | | |
| RDOptimization | = 1 | # rd-optimized mode decision (0:off, 1:on, 2: with losses) |
| LossRateA | = 10 | # expected packet loss rate of the channel for the first |

partition, only valid if RDOptimization = 2

| | | |
|---|---|---|
| LossRateB | = 0 | # expected packet loss rate of the channel for the second |

partition, only valid if RDOptimization = 2

| | | |
|---|---|---|
| LossRateC | = 0 | # expected packet loss rate of the channel for the third |

partition, only valid if RDOptimization = 2

| | | |
|---|---|---|
| NumberofDecoders | = 30 | # Numbers of decoders used to simulate the channel, only valid |
| if RDOptimization | = 2 | |
| RestrictRefFrames | = 0 | # Doesnt allow reference to areas that have been intra updated |
| in a later frame. | | |

##########################################################################################
# Additional Stuff
#########################################################################################

| | | |
|---|---|---|
| UseConstrainedIntraPred | = 0 | # If 1, Inter pixels are not used for Intra macroblock |
| prediction. | | |
| LastFrameNumber | = 0 | # Last frame number that have to be coded (0: no effect) |
| ChangeQPP | = 16 | # QP (P-frame) for second part of sequence (0-51) |
| ChangeQPB | = 18 | # QP (B-frame) for second part of sequence (0-51) |
| ChangeQPstart | = 0 | # Frame no. for second part of sequence (0: no second part) |
| AdditionalReferenceFrame | = 0 | # Additional ref. frame to check (news_a: 16; news_b,c: 24) |

| | | |
|---|---|---|
| NumberofLeakyBuckets | = 8 | # Number of Leaky Bucket values |
| LeakyBucketRateFile | = “leakybucketrate.cfg” | # File from which encoder derives rate |
| values | | |
| LeakyBucketParamFile | = “leakybucketparame.cfg” | # File where encoder stores |
| leakybucketparams | | |

| | | |
|---|---|---|
| InterlaceCodingOption | = 0 | # (0: frame coding, 1: adaptive frame/field coding, 2:field |
| coding, 3:mb adaptive f/f) | | |

| | | |
|---|---|---|
| NumberFramesInEnhancementLayerSubSequence | = 0 | # number of frames in the Enhanced |
| Scalability Layer(0: no Enhanced Layer) | | |
| NumberOfFrameInSecondIGOP | = 0 | # Number of frames to be coded in the |
| second IGOP | | |

| | | |
|---|---|---|
| WeightedPrediction | = 0 | # P picture Weighted Prediction (0=off, 1=explicit mode) |
| WeightedBiprediction | = 0 | # B picture Weighted Prediciton (0=off, 1=explicit mode, |
| 2=implicit mode) | | |
| StoredBPictures | = 0 | # Stored B pictures (0=off, 1=on) |
| SparePictureOption | = 0 | # (0: no spare picture info, 1: spare picture available) |
| SparePictureDetectionThr | = 6 | # Threshold for spare reference pictures detection |
| SparepicturePercentageThr | = 92 | # Threshold for the spare macroblock percentage |
| PicOrderCntType | = 0 | # (0: POC mode 0, 1: POC mode 1, 2: POC mode 2) |

##########################################################################################
# Loop filters parameters
##########################################################################################

| | | |
|---|---|---|
| LoopFilterParametersFlag | = 0 | # Configure loop filter (0=parameter below ingored, |
| 1=parameters sent) | | |
| LoopFilterDisable | = 0 | # Disable loop filter in slice header (0=Filter, 1=No Filter) |
| LoopFilterAlphaC0Offset | = −2 | # Alpha & CO offset div. 2, {−6, −5, . . . 0, +1, . . +6} |
| LoopFilterBetaOffset | = −1 | # Beta offset div. 2, {−6, −5, . . . 0, +1, . . +6} |

##########################################################################################
# CABAC context initalization
##########################################################################################

| | | |
|---|---|---|
| ContextInitMethod | = 1 | # Context init (0: fixed, 1: adaptive) |
| FixedModelNumber | = 0 | # model number for fixed decision for inter slices ( 0, 1, or 2 ) |

1. A video encoder comprising:
means for receiving an input video signal (201);
at least one encoder (303, 310, 320, 420, 430, 540, 810) for producing from the input video signal a scalable coding, the coding comprising at least a base encoded signal (130); an enhanced encoded signal (314); and an additional enhanced encoded signal (325, 435, 545),
wherein each encoder is compatible with at least one standard.

2. The encoder of claim 1, wherein at least one of the enhanced encoded signals (314) provides for SNR scalability and at least one of the enhanced encoded signals (325) provides for spatial scalability.

3. The encoder of claim 1, wherein the at least one encoder comprises at least three identical standards compatible encoding modules.

4. The encoder of claim 1, wherein all of the encoders operate in the pixel domain.

5. The encoder of claim 1, wherein each encoder is self-contained, so that, for production of each encoded layer, no internal results from other encoders are necessary.

6. A video encoder comprising:
means for receiving an input video stream (201); and at least one encoder/decoder (303/303′,310/310′, 420/420′,430/531, 810/810′) pair for supplying a plurality of encoded layers of a scalable output video stream, each encoder/decoder pair comprising a respective self-contained encoder module (303, 310, 420, 430, 810) and a respective self-contained decoder module (303′, 310′, 420′, 531, 810′) , which decoder module is distinct from the encoder module.

7. The encoder of claim 6, wherein the output video stream comprises at least 3 encoded layers (130, 314, 325, 435, 545).

8. The encoder of claim 6, wherein at least one of the encoded layers (314, 425, 545) yields gives SNR scalability and at least one other of the encoded layers (325, 435) yields spatial scalability.

9. The encoder of claim 6, wherein all of the encoder/decoder pairs are identical.

10. The encoder of claim 6, wherein each encoder and each decoder is self-contained, not requiring, for the production of an encoded layer, any internal processing results used in the production of any other encoded layer.

11. The encoder of claim 6, further comprising:
means for downscaling (202) the input video stream to create a downscaled stream;
means for upscaling (306, 406) signals derived from the input video stream to create an upscaled stream;
wherein at least two of encoded layers (130, 314,425), are derived from the downscaled stream and at least one of the encoded layers (325, 435, 545) is derived from the upscaled video stream.

12. The encoder of claim 6, comprising at least three encoder/decoder pairs wherein each encoder/decoder pair supplies a respective one of the encoded layers.

13. The encoder of claim 12, comprising at least four encoder/decoder pairs.

14. The encoder of claim 6, further comprising, for producing each respective encoded layer other than a base encoded layer:
at least one means for supplying a difference (207, 316, 407, 416, 516) between signals derived from the input video stream and from a decoded version of a prior encoded layer;
means for adding an offset (209, 319, 408, 418, 508) to a result of the difference to create an offset signal;
means for supplying the offset signal for encoding to produce the respective encoded layer.

15. The encoder of claim 6, wherein each encoder/decoder pair is a of a standards compatible type and operates in the pixel domain.

16. The encoder of claim 6, further comprising:
switching means (s1, s2, s3);
at least one means for supplying an offset (319, 209);
wherein there is only a single encoder/decoder pair (810/810′) and successive layers of encoding are produced from the single encoder/decoder pair using the switching means and the at least one means for supplying an offset to feed back results from prior encodings.

17. An encoder for providing a scalable video encoding, the encoder comprising:
means for receiving a single video input stream (201);
at least one encoder (303, 310, 320,420, 430, 540, 810) operating in the pixel domain for supplying at least three encoded layers from the video input, wherein for producing a base layer (130) the at least one encoder operates on a downscaled version of the single video input stream;
for production of each layer other than the first layer (314, 325, 425, 435, 545), the at least one encoder is coupled to receive a respective difference signal or a signal derived from the respective difference signal, the respective difference signal representing a difference between
either a downscaled version of the single video input stream or the single video input stream itself; and
either a decoded version of a previous encoded layer or an upscaled version of the decoded version of the previous encoded layer.

18. The encoder of claim 17, comprising means for supplying an offset (209, 319, 408, 418, 508) to each respective difference signal prior to applying the respective difference signal to the at least one encoder for production of a next layer.

19. The encoder of claim 17, wherein at least one of the encoded layers (325,435) gives spatial scalability and at least one of the encoded layers (314, 425, 545) gives SNR scalability.

20. An encoding method comprising:
receiving an input video signal;
encoding the video signal to produce an SNR and spatial scalable coding, the coding comprising a base encoded signal and at least two enhanced encoded signals, wherein the encoding uses at least one encoder, each encoder being of a standards compatible type.

21. The method of claim 20, wherein the encoding uses at least one encoder/decoder pair.

22. The method of claim 20, further comprising downscaling the input video signal to create a downscaled version of the video signal; and wherein the base encoded signal at least one of the enhanced encoded signals are produced from the downscaled version.

23. The method of claim 22 further comprising:
decoding the base encoded signal and the at least one of the enhanced encoded signals to produce decoded base and enhanced signals;
summing the decoded base and enhanced signals to create a sum decoded signal;
upscaling the sum decoded signal to create an upscaled signal;
encoding the upscaled signal to create at least one further enhanced encoded signal.

24. A decoder for decoding a scalable signal comprising at least first, second, and third standards compatible decoders (602, 607, 613) arranged in parallel, the first decoder (613) being for decoding a base layer encoded signal (130) and for providing therefrom a first scale of decoded image, and at least the second and third decoders (602, 607) being for decoding first (314) and second (325) enhanced layer encoded signals.

25. The decoder of claim 24, further comprising:
a first adder (611) coupled to add signals from or derived from the first and second decoders, and providing a second scale of decoded image; and
a second adder (604) coupled to add signals from or derived from the first adder and the third decoder and providing a third scale of decoded image.

26. The decoder of claim 25, further comprising:
first means (608) for offsetting, coupled between an output of the second decoder and the first adder;
second means (618) for offsetting, coupled between an output of the third decoder and the second adder.

27. The decoder of claim 26, further comprising means for upscaling (605), coupled between an output of the first adder and an input of the second adder.

28. A medium, readable by at least one processing device, embodying code for implementing functional modules comprising:
means for receiving an input video signal (201); and
at least one encoder (303, 310,320, 420, 430,540, 810) for producing from the input video signal a scalable coding, the coding comprising at least a base encoded signal (130); an enhanced encoded signal (314); and an additional enhanced encoded signal (325, 435, 545);
wherein each encoder is compatible with at least one standard.

29. A medium, readable by at least one processing device, embodying code for implementing functional modules comprising:
means for receiving an input video stream (201); and
at least one encoder/decoder (303/303′, 310/310′, 420/420′, 430/531, 810/810′) pair for supplying a plurality of encoded layers of a scalable output video stream, each encoder/decoder pair comprising a respective self-contained encoder module and a respective self-contained decoder module, which decoder module is distinct from the encoder module.

30. A medium, readable by at least one processing device, embodying code for implementing functional modules comprising:
means for receiving a single video input stream (201); and
at least one encoder (303, 310, 320, 420, 430, 540, 810) operating in the pixel domain for supplying at least three encoded layers from the video input; wherein
for producing a base layer the at least one encoder operates on a downscaled version of the single video input stream,
for production of each layer other than the first layer, the at least one encoder is coupled to receive a respective difference signal or a signal derived from the respective difference signal, the respective difference signal representing a difference between:
either a downscaled version of the single video input stream or the single video input stream itself; and
either a decoded version of a previous encoded layer or an upscaled version of the decoded version of the previous encoded layer.

31. A method of scalable video encoding comprising:
receiving a single video input stream;
downscaling the video input stream to produce a downscaled stream;
encoding the downscaled stream to produce a base encoded layer;
encoding a plurality of enhancement encoded layers, including producing a respective difference signal for each enhanced encoded layer, the respective difference signal representing a difference between:
either the downscaled stream or the single video input stream, on the one hand; and
either a decoded version of a previous encoded layer or an upscaled version of the decoded version of the previous encoded layer.

32. A medium, readable by at least one processing device, embodying code for implementing functional modules comprising at least first, second, and third standards compatible decoders (602, 607, 613) arranged in parallel, the first decoder (613) being for decoding a base layer encoded signal (130) and for providing therefrom a first scale of decoded image, and at least the second and third decoders (602, 607) being for decoding first (314) and second (325) enhanced layer encoded signals.
